(19) United States
(12) Patent Application Publication
(10) Pub. No.: US 2021/0087390 A1
(43) Pub. Date: Mar. 25, 2021

(54) THERMALLY STABILIZED COMPOSITIONS

(71) Applicant: LANXESS Deutschland GmbH, Cologne (DE)

(72) Inventors: Detlev JOACHIMI, Krefeld (DE); Thomas LINDER, Cologne (DE)

(73) Assignee: LANXESS Deutschland GmbH, Cologne (DE)

(21) Appl. No.: 16/630,554

(22) PCT Filed: Jul. 12, 2018
(86) PCT No.: PCT/EP2018/069000

§ 371 Date: Jan. 13, 2020

(30) Foreign Application Priority Data
Jul. 13, 2017 (EP) 17181105.2

(51) Int. Cl. C08L 77/06

(52) U.S. Cl. CPC C08L 77/06; B29B 9/06

(57) ABSTRACT

The present invention relates to heat-stabilized polyamide 66-based compositions containing reinforcing materials based on at least one semiaromatic polyamide, at least one phenolic antioxidant and at least one polyhydric alcohol, to molding materials producible therefrom and in turn to injection-molded, blow-molded or extruded articles of manufacture producible therefrom.

The present invention relates to heat-stabilized polyamide 66-based compositions containing reinforcing materials which further comprise at least one semiaromatic polyamide, at least one phenolic antioxidant and at least one polyhydric alcohol, to molding materials producible therefrom and in turn to injection-molded, blow-molded or extruded articles of manufacture producible therefrom.

Polyamides, in particular semicrystalline polyamides, are often used as materials of construction for moldings which are exposed to elevated temperatures over a prolonged period during their lifetime. It is necessary for a great many applications that the materials of construction be sufficiently stable toward the attendant thermooxidative damage, in particular for engine bay applications in motor vehicles. For information on thermooxidative damage see: P. Gijsman, e-Polymers, 2008, no. 065.

Glass fiber-reinforced polyamide 66 compounds in particular have become established in automobile construction for the production of articles of manufacture subject to high levels of thermal stress, wherein high levels of thermal stress is to be understood as meaning temperatures in the range from 180° C. to 240° C., temperatures which may nowadays occur in the engine bay of motor vehicles with combustion engines, in particular when the articles of manufacture are turbo charge air pipes, intake pipes, valve covers, charge air coolers or engine covers.

On account of the increases in motor vehicle engine performance realized in recent years, manufacturers impose ever higher requirements on the materials to be used for producing these articles of manufacture.

Polyamides generally exhibit a deterioration in their mechanical properties when they are subjected to elevated temperatures over a prolonged period. This effect is based primarily on oxidative damage to the polyamide at elevated temperatures (thermooxidative damage). A prolonged period in the context of the present invention means longer than 100 hours; elevated temperatures in the context of the present invention means higher than 80° C.

The stability of thermoplastic molding materials/articles of manufacture produced therefrom to thermooxidative damage is typically assessed by comparison of mechanical properties, in particular of impact resistance according to ISO180, of breaking stress and breaking elongation measured in the tensile test according to ISO 527, and of elastic modulus at a defined temperature over a defined period.

The thermooxidative degradation of thermoplastic, polyamide-based molding materials at elevated temperatures over a prolonged period generally cannot be prevented, only delayed, with stabilizer systems. The requirements imposed on polyamide-based molding materials/articles of manufacture producible therefrom in high-temperature applications are not yet sufficiently met by prior art heat-stabilizing systems. Especially component parts made of polyamide-based molding materials which further comprise at least one weld seam made by vibration, heating element, infrared, hot gas, ultrasound, spin or laser welding methods show a reduced stability, in particular in the region of the weld seam, after aging at temperatures in the abovementioned range.

In some cases it is also advantageous to use metal-free stabilizers since the traditional stabilizer systems based on metal salts such as copper iodide can in certain circumstances lead to corrosion of metal parts likewise installed in the engine compartment.

### PRIOR ART

For the heat stabilization of poly(N,N′-hexamethyleneadipinediamide), or poly(hexamethyleneadipamide), also referred to hereinbelow as polyamide 66 or PA 66 (CAS No. 32131-17-2), using a polyhydric alcohol and with a copper compound is known for example from WO 2010/014801 A1. WO 2010/014791 A1 describes the heat stabilization of PA66 with ethylene vinyl alcohol copolymer and copper iodide/potassium iodide.

However it was found that the use of metal salts or of metal salt-containing stabilizers in combination with a polyhydric alcohol can result in undesired side effects. These occur preferentially in the form of an impairment of the mechanical properties of articles of manufacture after 2500 h of hot air aging at temperatures above 200° C., for example in the particularly important range around 220° C., with impact strength in particular being affected.

Starting from the prior art the problem addressed by the present invention was that of improving the stabilization of polyamide 66-based compositions containing reinforcing materials and the articles of manufacture producible therefrom toward thermooxidative damage after 2500 h of hot air aging at temperatures around 220° C. doing without the use of metal-containing stabilizers such that the impact strength does not fall below 50% of the value measured on freshly molded test specimens.

### INVENTION

The solution to the problem and the subject matter of the present invention are compositions comprising
A) polyamide 66,
B) at least one semiaromatic polyamide,
C) at least one phenolic antioxidant,
D) at least one polyhydric alcohol and
E) at least one reinforcing material,
   with the proviso that A) and B) do not form a copolymer.

For the avoidance of doubt it is noted that the scope of the invention encompasses all hereinbelow-listed definitions and parameters referred to in general terms or within preferred ranges in any desired combinations. Citations of standards refer to the version valid on the application date of the present application.

### Definitions of Terms

The terms “above”, “at” or “about” used in the present description are intended to mean that the quantity or value that follows may be the specific value or a roughly equal value. The expression is intended to convey that similar values lead to results or effects that are equivalent according to the invention and are encompassed by the invention.

The nomenclature of the polyamides used in the context of the present application corresponds to the international standard, the first number(s) denoting the number of carbon atoms in the starting diamine and the last number(s) denoting the number of carbon atoms in the dicarboxylic acid. If only one number is stated, as in the case of PA 6, this means that the starting material was an α,ω-aminocarboxylic acid or the lactam derived therefrom, i.e. ε-caprolactam in the case of PA 6; for further information reference is made to DIN EN ISO 1874-1:2011-03.

Impact strength describes the capacity of a material of construction to absorb impact energy. Impact resistance is calculated as the ratio of impact energy to specimen cross section (unit of measurement: kJ/m²). Impact resistance can be determined by various kinds of (notched) impact flexural test (Charpy, Izod). Contrary to notched impact strength, in the case of impact strength the test specimen is not notched. In the context of the present invention tests were performed on upright test specimens, wherein the pendulum impacts the free end of the test specimen and the impact strength is determined on the unnotched or on the notched test specimen as per IZOD according to ISO 180 1U.

Processing of the components A) to E) for use according to the invention preferably affords compositions according to the invention, which in plastics technology are also referred to generally as molding materials, as pellets in strand form or as a powder. The preparation of compositions according to the invention is carried out by mixing the components to be employed according to the invention in at least one mixing unit, preferably in a compounder, particularly preferably a co-rotating twin-screw extruder, wherein in the context of the invention compositions, also referred to as preparations, also comprise purely physical mixtures formed during mixing of the relevant components. The mixing of the components A) to E) and optionally further components to produce compositions according to the invention in the form of powders, pellets or in strand form is often also referred to as compounding in the plastics industry. This affords, as intermediates, molding materials based on the compositions according to the invention. These molding materials—also referred to as thermoplastic molding materials—may either consist exclusively of components A), B), C), D) and E) or else may comprise in addition to the components A), B), C), D) and E) at least one further component.

With regard to the d10, d50 and d90 values in this application, their determination and their meaning, reference is made to Chemie Ingenieur Technik (72) pp. 273-276, 3/2000, Wiley-VCH Verlags GmbH, Weinheim, 2000, according to which the d10 value is the particle size below which 10% of the particle quantity lies, the d50 value is the particle size below which 50% of the particle quantity lies (median value) and the d90 value is the particle size below which 90% of the particle quantity lies.

### PREFERRED EMBODIMENTS OF THE INVENTION

The present invention preferably provides compositions containing

A) polyamide 66,

B) PA6I or PA6T, preferably PA6I,

C) at least one phenolic antioxidant,

D) at least one polyhydric alcohol and

E) at least one reinforcing material,

with the proviso that A) and B) do not form a copolymer.

However, the preferred subject of the present invention are also combustion engine components, in particular motor vehicle engine components based on compositions containing

Containing Compositions

A) Polyamide 66

B) at least one partially aromatic polyamide,

C) at least one phenolic antioxidant,

D) at least one polyhydric alcohol, and

E) at least one reinforcing material,
with the proviso that A) and B) do not form a copolymer.

However, particularly preferred subject of the present invention are also combustion engine components, in particular motor vehicle engine components based on compositions containing

Containing Compositions

A) polyamide 66,

B) PA6I or PA6T, preferably PA6I,

C) at least one phenolic antioxidant,

D) at least one polyhydric alcohol, and

E) at least one reinforcing material,
with the proviso that A) and B) do not form a copolymer

The present invention preferably relates to molding materials and articles of manufacture based on the compositions according to the invention, preferably combustion engine components, in particular automotive engine components, which employ based on 100 parts by mass of the component A) 6.0 to 50.0 parts by mass of the component B), 0.2 to 5.0 parts by mass of the component C), 1 to 5 parts by mass of the component D) and 17.5 to 185 parts by mass of the component E).

It is especially preferable to employ based on 100 parts by mass of the component A) 20 to 25 parts by mass of the component B), 0.01 to 0.1 parts by mass of the component C), 4 to 5 parts by mass of the component D) and 70 to 80 parts by mass of the component E).

In a preferred embodiment the compositions and the molding materials and articles of manufacture producible therefrom, preferably combustion engine components, in particular automotive engine components, contain in addition to the components A) to E) also F) at least one demolding agent, preferably in amounts in the range from 0.05 to 0.50 parts by mass based on 100 parts by mass of the component A).

In a preferred embodiment the compositions and the molding materials and articles of manufacture producible therefrom, preferably combustion engine components, in particular automotive engine components, contain in addition to the components A) to F) or instead of the components F) also G) at least one further additive distinct from the components B) to F), preferably in amounts in the range from 0.05 to 3.00 parts by mass based on 100 parts by mass of the component A).

Component A)

It is preferable to employ as component A) polyamide 66 having a relative solution viscosity in m-cresol in the range from 2.0 to 4.0. It is particularly preferable to employ polyamide 66 having a relative solution viscosity in m-cresol in the range of 2.6-3.2. Methods of determining relative solution viscosity comprise measuring the flow times for a dissolved polymer through an Ubbelohde viscometer in order then to determine the viscosity difference between the polymer solution and its solvent, in this case m-cresol (1% solution). Applicable standards are DIN 51562; DIN ISO 1628 or corresponding standards. In the context of the present invention, the viscosity is measured in sulfuric acid with an Ubbelohde viscometer according to DIN 51562 Part 1 with capillary II at 25° C. (±0.02° C.).

The polyamide 66 for use as component A) according to the invention preferably has 20 to 80 milliequivalents of amino end groups/1 kg of PA and 20 to 80 milliequivalents of acid end groups/1 kg of PA, particularly preferably 35 to 60 milliequivalents of amino end groups/1 kg of PA and 40 to 75 milliequivalents of acid end groups/1 kg of PA, wherein PA stands for polyamide. In the context of the present invention the amino end groups were determined in accordance with: G. B. Taylor, J. Am. Chem. Soc. 69, 635, 1947. Polyamide 66 [CAS No. 32131-17-2] for use as component A) according to the invention is obtainable from Ascend Performance Materials LLC under the trade mark Vydyne® for example.

Component B)

As component B) at least one semiaromatic polyamide is employed. Semiaromatic polyamides are polyamides whose monomers are in part derived from aromatic precursors.

The polyamides for use as component B) may be produced by various methods and synthesized from different building blocks. Semiaromatic polyamides are producible by a multiplicity of procedures, wherein depending on the desired end product, different monomeric building blocks, various chain transfer agents for achieving a target molecular weight, or else monomers having reactive groups for subsequently intended aftertreatments may be employed.

The industrially relevant processes for producing the polyamides for use as component B) usually proceed via polycondensation in the melt. In the context of the present invention the hydrolytic polymerization of lactams is also considered to be polycondensation.

Semiaromatic polyamides preferred for use as component B) according to the invention are based on α,ω-diamines and at least one benzenedicarboxylic acid.

Preferred benzene dicarboxylic acids are isophthalic acid or terephthalic acid, preferably isophthalic acid. Preferred optionally additional aromatic constructional units are selected from phenylenediamine or xylylenediamine. Preferred α,ω-diamines are 1,4-diaminobutane (hexabutylenediamine) or 1,6-diaminobutane (hexamethylenediamine), in particular hexamethylenediamine.

Semiaromatic polyamides particularly preferred for use as component B) are based on isophthalic acid (PA6I) [CAS No. 25668-34-2] or terephthalic acid (PA6T) [CAS No. 24938-70-3] and on hexamethylenediamine [CAS No. 124-09-4]. Very particular preference is given to PA6I which is obtainable inter alia as Durethan® T40 from LANXESS Deutschland GmbH, Cologne.

Component C)

As component C) at least one sterically hindered phenol, usually referred to as phenolic antioxidant, is employed. Component C) preferably contains at least one unit of the formula

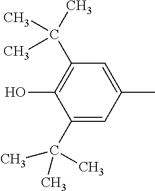

It is particularly preferable to employ 1,6-bis(3,5-di-tert-butyl-4-hydroxyhydrocinnamido)hexane [CAS No. 23128-74-7] which is obtainable inter alia from BASF AG, Ludwigshafen under the name Irganox® 1098.

Component D)

As component D) at least one polyhydric alcohol is employed. It is preferable to employ a polyhydric alcohol having more than two hydroxyl groups. It is very particularly preferable to employ at least one polyhydric alcohol from the group of dipentaerythritol, tripentaerythritol, pentaerythritol and mixtures thereof. Especially preferred according to the invention is dipentaerythritol [CAS No. 126-58-9] which is obtainable for example from Sigma-Aldrich.

Component E)

As component E) it is preferable to use fibrous, acicular or particulate fillers and reinforcers. It is preferable to employ at least one filler and reinforcer from the group of carbon fibers [CAS No. 7440-44-0], glass beads, solid or hollow glass beads, for example [CAS No. 65997-17-3], ground glass, amorphous silica [CAS No. 7631-86-9], calcium silicate [CAS No. 1344-95-2], calcium metasilicate [CAS No. 10101-39-0], magnesium carbonate [CAS No. 546-93-0], kaolin [CAS No. 1332-58-7], calcined kaolin [CAS No. 92704-41-1], chalk [CAS No. 1317-65-3], kyanite [CAS No. 1302-76-7], powdered or ground quartz [CAS No. 14808-60-7], mica [CAS No. 1318-94-1], phlogopite [CAS No. 12251-00-2], barium sulfate [CAS No. 7727-43-7], feldspar [CAS No. 68476-25-5], wollastonite [CAS No. 13983-17-0], montmorillonite [CAS No. 67479-91-8] and glass fibers [CAS No. 65997-17-3].

A “fiber” in the context of the present invention is a macroscopically homogeneous body having a high ratio of length to cross-sectional area. The fiber cross section may be any desired shape but is generally round or oval.

According to “http://de.wikipedia.org/wiki/Faser-Kunststoff-Verbund” a distinction is made between
chopped fibers, also known as short fibers, having an average length in the range from 0.1 to 5 mm, preferably in the range from 3 to 4.5 mm,
long fibers having an average length in the range from 5 to 50 mm and
endless fibers having an average length L>50 mm.

Fiber lengths can be determined for example by microfocus x-ray computer tomography (μ-CT); J. Kastner et. al., Quantitative Messung von Faserlängen und-verteilung in faserverstärkten Kunststoffteilen mittels μ-Röntgen-Computertomographie, DGZfP-Jahrestagung 2007—paper 47, pages 1-8.

It is particularly preferable to employ glass fibers, very particularly preferably glass fibers made of E-glass. It is especially preferable to use the glass fibers as short glass fibers for molding materials used in injection molding. When using the compositions according to the invention as a matrix polymer for composites, the glass fibers are preferably employed as endless fibers and/or long fibers.

In a preferred embodiment the fibrous or particulate fillers and reinforcers are provided with suitable surface modifications, preferably with surface modifications comprising silane compounds, for better compatibility with the component A). Especially preferably used as component E) are glass fibers having a circular cross-sectional area and a filament diameter in the range from 6 to 14 μm or flat glass fibers of noncircular cross-sectional area whose principle cross-sectional axis has a width in the range from 6 to 40 μm and whose secondary cross-sectional axis has a width in the range from 3 to 20 μm, where data reported in the glass fiber manufacturer technical datasheets are to be used to determine whether a glass fiber product belongs to this dimension range. For example, glass fiber CS7928 from Lanxess Deutschland GmbH (circular cross section, average diameter 11 μm) may be used with especial preference. In the context of the present invention cross-sectional area/filament diameter are determined by means of at least one optical method according to DIN 65571. Optical methods are a) optical microscope and ocular micrometer (distance measurement cylinder diameter), b) optical microscope and digital camera with subsequent planimetry (cross-section measurement), c) laser interferometry and d) projection.

All reported lengths, widths or diameters for the fillers and reinforcers listed here are averaged figures (d₅₀ value) and relate to the state prior to compounding. Having regard to the d₅₀ values in this application, the determination thereof and the meaning thereof, reference is made to Chemie Ingenieur Technik 72, 273-276, 3/2000, Wiley-VCH Verlags GmbH, Weinheim, 2000, according to which the d₅₀ value is the particle size below which 50% of the particles lie (median).

Component F)

Demolding agents for use as component F) according to the invention are preferably ester derivatives or amide derivatives of long-chain fatty acids, in particular ethylene-bis-stearylamide, glycerol tristearate, stearyl stearate, montan ester waxes, in particular esters of montan acids with ethylene glycol and low molecular weight polyethylene/polypropylene waxes in oxidized and non-oxidized form. Demolding agents particularly preferred according to the invention belong to the group of esters or amides of saturated or unsaturated aliphatic carboxylic acids having 8 to 40 carbon atoms with saturated aliphatic alcohols or amines having 2 to 40 carbon atoms. In a further preferred embodiment the compositions/molding materials according to the invention comprise mixtures of the recited demolding agents. Montan ester waxes, also known as montan waxes [CAS No. 8002-53-7] for short, preferred for use as demolding agents are esters of mixtures of straight-chain, saturated carboxylic acids having chain lengths in the range from 28 to 32 carbon atoms. Such montan ester waxes are commercially available for example from Clariant International Ltd. under the name Licowax®. Especially preferred according to the invention is Licowax® E or a mixture of waxes, preferably mixtures of ester waxes and amide waxes such as described in EP2607419 A1.

Component G)

As the additive for use as component G) it is preferable to employ at least one substance from the group of heat stabilizers distinct from components C) and D), UV stabilizers, gamma ray stabilizers, hydrolysis stabilizers, antistats, nucleating agents, plasticizers, processing aids, impact modifiers, dyes, pigments and flame retardants. These and further suitable additives are prior art and may be found by those skilled in the art for example in Plastics Additives Handbook, 5th Edition, Hanser-Verlag, Munich, 2001, pages 80-84, 546-547, 688, 872-874, 938, 966. The additives for use as component G) may be used individually or in admixture or in the form of masterbatches.

Additional heat stabilizers for use as additives according to the invention and distinct from the components C) and D) are preferably sterically hindered phosphites, hydroquinones, substituted resorcinols, salicylates, benzotriazoles or benzophenones, and variously substituted representatives of these groups and/or mixtures thereof. Explicitly excluded are aromatic secondary amines and hindered aromatic amines (HALS).

UV-stabilizers for use as an additive according to the invention are preferably substituted resorcinols, salicylates, benzotriazoles or benzophenones.

Impact modifiers or elastomer modifiers for use as an additive are preferably copolymers preferably constructed from at least two monomers of the following series: ethylene, propylene, butadiene, isobutene, isoprene, chloroprene, vinyl acetate, styrene, acrylonitrile and acrylic esters or methacrylic esters having 1 to 18 carbon atoms in the alcohol component. The copolymers may contain compatibilizing groups, preferably maleic anhydride or epoxide.

Dyes or pigments for use as an additive according to the invention are preferably inorganic pigments, particularly preferably titanium dioxide, ultramarine blue, iron oxide, zinc sulfide or carbon black, and also organic pigments, particularly preferably phthalocyanines, quinacridones, perylenes, and dyes, particularly preferably nigrosine or anthraquinones, and also other colorants.

Nucleating agents for use as an additive according to the invention are preferably sodium or calcium phenylphosphinate, aluminum oxide, silicon dioxide or talc. It is particularly preferable to employ talc [CAS-No. 14807-96-6] as the nucleating agent, in particular microcrystalline talc such microcrystalline talc has an average particle size d50, measured according to Sedigraph, in the range from 0.5 to 10 μm. See: Micromeritics Instrument Corp, The Science and Technology of Small Particles, Norcross, USA, Part #512/42901/00.

Flame retardants for use as an additive according to the invention are preferably mineral flame retardants, nitrogen-containing flame retardants or phosphorus-containing flame retardants.

Among the mineral flame retardants magnesium hydroxide is particularly preferred. Magnesium hydroxide [CAS No. 1309-42-8] may be impurified as a result of its origin and mode of production. Typical impurities include for example silicon-, iron-, calcium- and/or aluminum-containing species which may for example be present in the form of oxides as guest species in the magnesium hydroxide crystals. The magnesium hydroxide for use according to the invention may be unsized or else provided with a size, wherein a size is an impregnation liquid for imparting the surface of a substance with certain properties. The magnesium hydroxide for use according to the invention is preferably provided with sizes based on stearates or aminosiloxanes, particularly preferably with aminosiloxanes. Magnesium hydroxide preferred for use has an average particle size d₅₀ in the range from 0.5 μm to 6 μm, wherein a d₅₀ in the range from 0.7 μm to 3.8 μm is preferred and a d₅₀ in the range from 1.0 μm to 2.6 μm is particularly preferred and the average particle size is determined by laser diffractometry according to ISO 13320.

Magnesium hydroxide types suitable in accordance with the invention include for example Magnifin® H5IV from Martinswerk GmbH, Bergheim, Germany or Hidromag® Q2015 TC from Penoles, Mexico City, Mexico.

Preferred nitrogen-containing flame retardants are the reaction products of trichlorotriazine, piperazine and morpholine of CAS No. 1078142-02-5, in particular MCA PPM Triazine HF from MCA Technologies GmbH, Biel-Benken, Switzerland, also melamine cyanurate and condensation products of melamine, for example melem, melam, melon or more highly condensed compounds of this type. Preferred inorganic nitrogen-containing compounds are ammonium salts.

It is further also possible to use salts of aliphatic and aromatic sulfonic acids and mineral flame retardant additives such as aluminum hydroxide, Ca—Mg carbonate hydrates (for example DE-A 4 236 122).

Also suitable are flame retardant synergists from the group of oxygen-, nitrogen- or sulfur-containing metal compounds, particular preference being given to zinc-free compounds, especially molybdenum oxide, magnesium oxide, magnesium carbonate, calcium carbonate, calcium oxide, titanium nitride, magnesium nitride, calcium phosphate, calcium borate, magnesium borate or mixtures thereof.

However, in an alternative embodiment zinc-containing compounds may also be employed as component G) if required. These preferably include zinc oxide, zinc borate, zinc stannate, zinc hydroxystannate, zinc sulfide and zinc nitride, or mixtures thereof.

Preferred phosphorus-containing flame retardants are organic metal phosphinates, such as e.g. aluminum tris(diethylphosphinate), aluminum salts of phosphonic acid, red phosphorus, inorganic metal hypophosphites, particularly aluminum hypophosphite, further metal phosphonates, especially calcium phosphonate, derivatives of 9,10-dihydro-9-oxa-10-phosphaphenanthrene 10-oxides (DOPO derivatives), resorcinol bis(diphenyl phosphate) (RDP) including oligomers, and bisphenol A bis(diphenyl phosphate) (BDP) including oligomers, and also melamine pyrophosphate and melamine polyphosphate, also melamine poly(aluminum phosphate), melamine poly(zinc phosphate) or phenoxyphosphazene oligomers and mixtures thereof.

Further flame retardants for use as component G) are char formers, particularly preferably phenol-formaldehyde resins, polycarbonates, polyimides, polysulfones, polyether sulfones or polyether ketones, and also anti-drip agents, especially tetrafluoroethylene polymers.

The flame retardants for use as component G) may be added in pure form or else via masterbatches or compactates.

However, in an alternative embodiment—if required and taking into account the disadvantages of loss of freedom from halogen of the flame retardants—halogen-containing flame retardants may also be employed as flame retardants. Preferred halogen-containing flame retardants are commercially available organic halogen compounds, particularly preferably ethylene-1,2-bistetrabromophthalimide, decabromodiphenylethane, tetrabromobisphenol A epoxy oligomer, tetrabromobisphenol A oligocarbonate, tetrachlorobisphenol A oligocarbonate, polypentabromobenzyl acrylate, brominated polystyrene or brominated polyphenylene ethers, which can be used alone or in combination with synergists, especially antimony trioxide or antimony pentoxide, wherein among the halogenated flame retardants brominated polystyrene is particularly preferred. Brominated polystyrene is commercially available in a very wide variety of product qualities. Examples thereof are for example Firemaster® PBS64 from Lanxess, Cologne, Germany and Saytex® HP-3010 from Albemarle, Baton Rouge, USA.

Among the flame retardants for use as component G) aluminum tris(diethylphosphinate) [CAS No. 225789-38-8] and the combination of aluminum tris(diethylphosphinate) and melamine polyphosphate or the combination of aluminum tris(diethylphosphinate) and at least one aluminum salt of phosphonic acid are very particularly preferred, where the latter combination is especially preferred.

A suitable aluminum tris(diethylphosphinate) is for example Exolit® OP1230 or Exolit® OP1240 from Clariant International Ltd. Muttenz, Switzerland. Melamine polyphosphate is commercially available in a very wide variety of product qualities. Examples thereof are for example Melapur® 200/70 from BASF, Ludwigshafen, Germany, and also Budit® 3141 from Budenheim, Budenheim, Germany.

Preferred aluminum salts of phosphonic acid are selected from the group

primary aluminum phosphonate [Al(H₂PO₃)₃],

basic aluminum phosphonate [Al((OH)H₂PO₃)₂.2H₂O],

Al₂(HPO₃)₃.xAl₂O₃.nH₂O where x is in the range from 2.27 to 1 and n is in the range from 0 to 4,

Al₂(HPO₃)₃.(H₂O)_{q} (Z1)

where q is in the range from 0 to 4, in particular aluminum phosphonate tetrahydrate [Al₂(HPO₃)₃.4H₂O] or secondary aluminum phosphonate [Al₂(HPO₃)₃],

Al₂M_{z}(HPO₃)_{y}(OH)ᵥ.(H₂O)_{w} (Z2)

in which M means alkali metal ion(s) and z is in the range from 0.01 to 1.5, y in the range of 2.63-3.5, v in the range from 0 to 2 and w is in the range of 0 to 4, and

Al₂(HPO₃)ᵤ(H₂PO₃)ₜ.(H₂O)ₛ (Z3)

in which u is in the range of 2 to 2.99, t is in the range from 2 to 0.01 and s is in the range from 0 to 4,

wherein in formula (Z2) z, y and v and in formula (Z3) u and t can assume only numbers such that the relevant aluminum salt of phosphonic acid as a whole is uncharged.

Preferred alkali metals in formula (Z2) are sodium and potassium.

The described aluminum salts of phosphonic acid may be used individually or in admixture.

Particularly preferred aluminum salts of phosphonic acid are selected from the group

primary aluminum phosphonate [Al(H₂PO₃)₃],

secondary aluminum phosphonate [Al₂(HPO₃)₃],

basic aluminum phosphonate [Al((OH)H₂PO₃)₂.2H₂O],

aluminum phosphonate tetrahydrate [Al₂(HPO₃)₃.4H₂O] and

Al₂(HPO₃)₃.x Al₂O₃.nH₂O where x is in the range from 2.27 to 1 and n is in the range from 0 to 4.

Very particular preference is given to secondary aluminum phosphonate [Al₂(HPO₃)₃, CAS No. 71449-76-8] and secondary aluminum phosphonate tetrahydrate [Al₂(HPO₃)₃.[4 H₂O, CAS No. 156024-71-4], secondary aluminum phosphonate being especially preferred [Al₂(HPO₃)₃].

Production of the aluminum salts of phosphonic acid for use according to the invention is described in WO 2013/083247 A1 for example.

In one embodiment of the present invention it is possible to employ as component G) polyamide 6 (PA 6) with the proviso that the PA 6 forms a copolymer neither with component A) nor with component B). PA 6 [CAS No. 25038-54-4] is a semicrystalline thermoplastic obtainable for example from Lanxess Deutschland GmbH, Cologne, under the name Durethan®. According to DE 10 2011 084 519 A1 semicrystalline polyamides have a melting enthalpy in the range from 4 to 25 J/g measured by the DSC method according to ISO 11357 in the 2nd heating and integration of the melting peak.

The present invention preferably relates to compositions containing A) PA 66, B) PA6I, C) phenolic antioxidant, D) dipentaerythritol, E) glass fibers and also to molding materials and articles of manufacture producible therefrom.

The present invention preferably relates to compositions containing A) PA 66, B) PA6T, C) phenolic antioxidant, D) dipentaerythritol, E) glass fibers and also to molding materials and articles of manufacture producible therefrom.

The present invention preferably relates to compositions containing A) PA 66, B) semiaromatic PA, C) phenolic antioxidant, D) dipentaerythritol, E) glass fibers and G) PA 6 and also to molding materials and articles of manufacture producible therefrom.

The present invention preferably relates to compositions containing A) PA 66, B) semiaromatic PA, C) phenolic antioxidant, D) dipentaerythritol, E) glass fibers and G) PA 6 in proportions less than or equal to the proportions of the component B) and also to molding materials and articles of manufacture producible therefrom.

The present invention preferably relates to compositions containing A) PA 66, B) PA 6I, C) 1,6-bis(3,5-di-tert-butyl-4-hydroxyhydrocinnamido)hexane, D) dipentaerythritol, E) glass fibers and also to molding materials and articles of manufacture producible therefrom.

The present invention preferably relates to compositions containing A) PA 66, B) PA 6T, C) 1,6-bis(3,5-di-tert-butyl-4-hydroxyhydrocinnamido)hexane, D) dipentaerythritol, E) glass fibers and also to molding materials and articles of manufacture producible therefrom.

The present invention preferably relates to compositions containing A) PA 66, B) semiaromatic PA, C) 1,6-bis(3,5-di-tert-butyl-4-hydroxyhydrocinnamido)hexane, D) dipentaerythritol, E) glass fibers and G) PA 6 and also to molding materials and articles of manufacture producible therefrom.

The present invention preferably relates to compositions containing A) PA 66, B) semiaromatic PA, C) 1,6-bis(3,5-di-tert-butyl-4-hydroxyhydrocinnamido)hexane, D) dipentaerythritol, E) glass fibers and G) PA 6 in proportions less than or equal to the proportions of the component B) and also to molding materials and articles of manufacture producible therefrom.

Process

The present invention further relates to a process for producing articles of manufacture wherein the components of the inventive compositions are mixed, extruded to form a molding material in the form of a strand, cooled until pelletizable and pelletized and subjected as matrix material to an injection molding, blow molding or extrusion operation, preferably an injection molding operation. Articles of manufacture according to the invention may also be composites based on endless fibers or long fibers, preferably glass-based endless fibers or glass-based long fibers, such as are known to those skilled in the art for example from DE 10 2006 013 684 A1 or DE 10 2004 060 009 A1.

Preferably concerned here are the components A) to E) and optionally also at least one representative of the components F) and G). It is preferable when the mixing of the components is effected at temperatures in the range from 220° C. to 400° C. by mutual combining, mixing, kneading, extruding or rolling. Preferred mixing units may be selected from compounders, co-rotating twin-screw extruders and Buss kneaders. It may be advantageous to premix individual components. The term “compound” refers to mixtures of raw materials to which fillers, reinforcers or other additives have additionally been added. Thus compounding combines at least two substances with one another to afford a homogeneous mixture. The procedure for producing a compound is known as compounding.

It is preferable when in a first step at least one of components B), C), D) and E) is mixed with component A) or with PA 6 as component G) to afford a premixture. It is preferable when this first step is performed at temperatures of <50° C. in a helical mixer, double-cone mixer, Lödige mixer or similar mixing units suitable for mixing solids. Alternatively, premixing in a co-rotating twin-screw extruder, Buss kneader or planetary roll extruder at a temperature above the melting point of component A) or G) PA 6 may be advantageous. It is preferable when the mixing units are equipped with a degassing function.

After mixing the obtained molding materials are preferably discharged as a strand, cooled until pelletizable and pelletized. In one embodiment, the obtained pelletized material is dried, preferably at temperatures in the range from 70° C. to 130° C., preferably in a vacuum drying cabinet or in a dry air dryer. For further processing by injection molding the residual moisture content should be adjusted to a value of preferably less than 0.12%. For extrusion processing, in particular by blow-molding, a residual moisture content of not more than 0.06% should be observed.

Direct production of so-called semifinished products from a physical mixture produced at room temperature, preferably at a temperature in the range from 10° C. to 40° C., a so-called dryblend, of premixed components and/or individual components may be advantageous. In the context of the present invention semifinished products are prefabricated items and are formed in a first step in the process for producing an article of manufacture. In the context of the present invention the term “semifinished products” does not comprise bulk goods, pelletized materials or powders because, unlike semifinished products, these are not geometrically defined solid objects and as such no “semifinishing” of a final article of manufacture has been effected. See: http://de.wikipedia.org/wiki/Halbzeug. According to the invention the term “article of manufacture” thus also comprises semifinished products.

The processes of injection molding, of blow molding and of extrusion of thermoplastic molding materials are known to those skilled in the art.

Processes according to the invention for producing polyamide-based articles of manufacture by extrusion or injection molding are performed at melt temperatures in the range from 250° C. to 330° C., preferably in the range from 260° C. to 310° C., particularly preferably in the range from 270° C. to 300° C., and in the case of injection molding at injection pressures of not more than 2500 bar, preferably at injection pressures of not more than 2000 bar, particularly preferably at injection pressures of not more than 1500 bar and very particularly preferably at injection pressures of not more than 750 bar.

The articles of manufacture producible according to the invention from the molding materials may preferably be employed for applications where a high stability toward heat aging is necessary, preferably in the motor vehicle, electrical, electronic, telecommunications, solar, information technology and computer industries, in the household, in sport, in medicine or in the leisure industry. Preference for such applications is given to the use of articles of manufacture in vehicles, particularly preferably in motor vehicles having an internal combustion engine, in particular in motor vehicle engine bays. The compositions according to the invention are especially preferably suitable for producing welded components having at least one weld seam made by vibration, heating element, infrared, hot gas, ultrasound, spin or laser welding methods.

The present invention therefore also relates to the use of thermoplastic molding materials containing the abovementioned components in the form of compositions for production of articles of manufacture having elevated stability to thermooxidative damage, preferably of articles of manufacture for motor vehicles, particularly preferably of articles of manufacture for engine bays of motor vehicles, especially preferably of articles of manufacture having at least one weld seam, in particular a weld seam made by vibration, heating element, infrared, hot gas, ultrasound, spin or laser welding methods. The molding materials according to the invention are also suitable for applications/moldings or articles where, in addition to thermooxidative stability, stability toward photooxidative damage is also necessary, preferably solar installations.

In a preferred embodiment the articles of manufacture producible in accordance with the invention are semifinished products in the form of heat-stabilized composites based on endless fibers, also known as organopanels, or else encapsulated or overmolded composite structures. The inventive compositions/the inventive heat stabilizer system may be used/may be present either in the thermoplastic matrix of the composite structure or in the molding material to be molded or in both components. Heat-stabilized composites are known for example from WO 2011/014754 A1 and overmolded composite structures are described for example in WO 2011/014751 A1.

The present invention yet further relates to a process for heat stabilization of polyamide 66 and in particular of the weld seams of polyamide 66-based components by employing a stabilizer system composed of semiaromatic polyamide, dipentaerythritol and phenolic antioxidant, preferably a stabilizer system composed of PA6I, dipentaerythritol, and phenolic antioxidant, wherein the polyamide 66 is not in the form of a copolymer with the semiaromatic polyamide.

The present application yet further relates to a process for reducing photooxidative damage and/or thermooxidative damage to polyamide 66 admixed with at least one reinforcer or articles of manufacture producible therefrom in the form of films, fibers or moldings by employing a stabilizer system based on a semiaromatic polyamide, at least one polyhydric alcohol and at least one phenolic antioxidant, wherein the polyamide 66 is not in the form of a copolymer with the semiaromatic polyamide.

The articles of manufacture are preferably polyamide 66-based composite structures and overmolded composite structures but also polyamide 66-based components provided with weld seams.

Preferably employed as a stabilizer system is a semiaromatic polyamide, dipentaerythritol and phenolic antioxidant, particularly preferably a stabilizer system composed of PA6I, dipentaerythritol, and phenolic antioxidant.

The invention finally relates to the use of a stabilizer system based on a semiaromatic polyamide, at least one polyhydric alcohol and at least one phenolic antioxidant for reducing photooxidative damage and/or thermooxidative damage to polyamide 66 admixed with at least one reinforcer or articles of manufacture producible therefrom in the form of films, fibers or moldings, wherein the polyamide 66 is not in the form of a copolymer with the semiaromatic polyamide.

However, the preferred subject of the present invention are also combustion engine components, in particular motor vehicle engine components, based on compositions containing

A) polyamide 66,

B) PA6I or PA6T, preferably PA6I,

C) at least one phenolic antioxidant,

D) at least one polyhydric alcohol, and

E) at least one reinforcing material,

with the proviso that A) and B) do not form a copolymer, which are turbocharged air ducts, intake manifolds, valve covers, intercoolers or engine covers.

### EXAMPLES

To demonstrate the advantages of compositions according to the invention and articles of manufacture producible therefrom, molding materials were initially produced in an extruder. Articles of manufacture in the form of flat bars obtained from the molding materials by injection molding were subsequently tested as unnotched test specimens in the freshly molded state and after prior aging in an impact test according to DIN EN ISO 180 1-U.

Production of the Polyamide Molding Materials

The individual components listed in table 1 were mixed in a ZSK 26 Compounder twin-screw extruder from Coperion Werner & Pfleiderer (Stuttgart, Germany) at a temperature of about 290° C., extruded in the form of a strand into a water bath, cooled until pelletizable and pelletized. The pelletized material was dried at 70° C. in the vacuum drying cabinet for about two days down to a residual moisture content of less than 0.12%.

Materials Used in the Context of the Present Invention:
Component A): Polyamide 66, Vydyne® 50 BWFS from Ascend Performance Materials LLC
Component B): semiaromatic polyamide PA6I, Durethan® T40 from Lanxess Deutschland GmbH
Component C): Irganox® 1098 from BASF
Component D): dipentaerythritol [CAS No. 126-58-9]
Component E): Glass fibers, chopped strands CS7928 from Lanxess Deutschland GmbH

Further Components Employed:

Polyamide 6, Durethan® B29 from Lanxess Deutschland GmbH

Montan ester wax Licowax® E from Clariant GmbH

Carbon black masterbatch: 50% in polyethylene

Nigrosin base NB masterbatch (Solvent Black 7) 40% in PA 6

TABLE 1
Compositions of molding materials (parts by
mass based on 100 parts by mass of PA66)

| Ingredient | Comp. 1 | Ex. 1 |
|---|---|---|
| PA66 | 100.00 | 100.00 |
| PA6I | 0.00 | 20.13 |
| Copper(I) iodide | 0.06 | |
| Phenolic antioxidant | | 1.11 |
| Dipentaerythritol | 3.39 | 4.42 |
| Glass fibers | 59.39 | 77.43 |

The glass fiber proportion in all molding materials was 35% of the total weight. The different values for the mass fractions of glass fibers come about since the compositions are based on 100 parts by mass of PA66 and this proportion changes as a result of the different amounts of additions.

Injection Molding:

The injection molding of the molding materials obtained was performed on an SG370-173732 injection molding machine from Arburg. The melt temperature was 290° C. and the mold temperature was 80° C. Flat bars according to DIN EN ISO 180 1-U and having nominal dimensions of 80 mm×10 mm×4 mm were molded as test specimens.

Aging and Testing:

In order to test aging behavior the test specimens were stored at 220° C. in a recirculating air drying cabinet for 1000 hours, 2000 hours and 3000 hours and subsequently tested in a Zwick impact testing machine under the conditions of ISO 180 1-U. The results obtained from the measurements were expressed relative to the initial value to determine therefrom the retention of impact strength after hot air aging.

TABLE 2
Results of hot air aging at 220° C. (Impact tests were carried
out at room temperature (23 +/− 2° C.)

Composition

| | Comparison Example 1 | Inventive example 1 |
|---|---|---|
| | Ageing at 220° C. | Ageing at 220° C. |
| 0 h | 69 | 58 |
| 1000 h | 38 | 48 |
| rel. retention | 55% | 83% |
| 2000 h | 1 | 37 |
| rel. retention | 1% | 63% |
| 2500 h | — | 32 |
| rel. retention | — | 55% |

Surprisingly, the use of semiaromatic polyamides in PA66 compounds has the result that after hot air aging at 220° C. even after 2500 hours the impact strength is retained markedly above a value of 50% (rel. retention), thus demonstrating the markedly improved heat aging stability of compositions according to the invention/articles of manufacture producible therefrom.

1. A composition comprising:
A) polyamide 66,
B) at least one semiaromatic polyamide,
C) at least one phenolic antioxidant,
D) at least one polyhydric alcohol, and
E) at least one reinforcing material,
with the proviso that A) and B) do not form a copolymer.

2. The composition as claimed in claim 1, wherein based on 100 parts by mass of the component A) 6.0 to 50.0 parts by mass of the component B), 0.01 to 0.30 parts by mass of the component C), 1 to 5 parts by mass of the component D) and 17.5 to 185 parts by mass of the component E).

3. The composition as claimed in the claim 1, wherein component C) contains at least one unit of the formula (I)

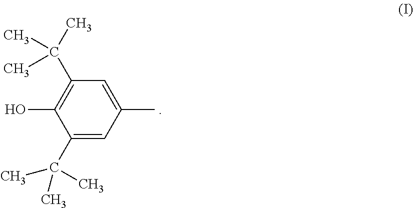

4. The composition as claimed in claim 1, wherein component C) comprises 1,6-bis(3,5-di-tert-butyl-4-hydroxyhydrocinnamido)hexane.

5. The composition as claimed in claim 1, further comprising F) at least one demolding agent.

6. The composition as claimed in claim 1, further comprising G) at least one further additive distinct from components B) to F).

7. The composition as claimed in claim 1, wherein the semiaromatic polyamides employed are based on isophthalic acid or terephthalic acid and hexamethylenediamine.

8. The composition as claimed in claim 1, wherein component D) comprises a polyhydric alcohol having more than two hydroxyl groups.

9. The composition as claimed in claim 8, wherein the polyhydric alcohol is selected from the group of dipentaerythritol, tripentaerythritol, pentaerythritol and mixtures thereof.

10. The composition as claimed in claim 1, wherein component E) is selected from the group of carbon fibers, glass spheres, solid or hollow glass spheres, ground glass, amorphous silica, kyanite, calcium silicate, calcium metasilicate, magnesium carbonate, kaolin, calcined kaolin, chalk, powdered or ground quartz, mica, phlogopite, barium sulfate, feldspar, wollastonite, montmorillonite and glass fibers.

11. Combustion engine components comprising compositions according to claim 1.

12. Combustion engine components according to claim 11 selected from the group of turbocharged air ducts, intake pipes, valve covers, intercoolers and engine covers.

13. A molding material and article of manufacture producible therefrom containing a composition as claimed in claim 1.

14. A process for producing articles of manufacture, comprising:
mixing the components of the compositions as claimed in claim 1 to form a mixture,
extruding the mixture to form a molding material in the form of a strand,
cooling and pelletizing the molding material to form a matrix material and subjecting the matrix material to injection molding, a blow molding operation or extrusion.

15. The use of a stabilizer system based on a semiaromatic polyamide, at least one polyhydric alcohol and at least one phenolic antioxidant for reducing photooxidative damage and/or thermooxidative damage to polyamide 66 admixed with at least one reinforcer or articles of manufacture producible therefrom in the form of films, fibers or moldings, wherein the polyamide 66 is not in the form of a copolymer with the semiaromatic polyamide.

16. The composition as claimed in claim 5, wherein component F) is present in an amount of from 0.05 to 0.50 parts by mass based on 100 parts by mass of the component A).

17. The composition as claimed in claim 6, wherein component G) is present in an amount of from 0.05 to 3.00 parts by mass based on 100 parts by mass of component A).

18. The composition as claimed in claim 8, wherein the polyhydric alcohol is dipentaerythritol.
